(19) United States
(12) Patent Application Publication
(10) Pub. No.: US 2025/0244924 A1
(43) Pub. Date: Jul. 31, 2025

(54) IMAGE FORMING APPARATUS, CONTROL METHOD OF IMAGE FORMING APPARATUS, AND NON-TRANSITORY COMPUTER READABLE MEDIUM

(71) Applicant: CANON KABUSHIKI KAISHA, Tokyo (JP)

(72) Inventors: SHO MIYAZAKI, Kanagawa (JP); ISAO HAYASHI, Tokyo (JP)

(21) Appl. No.: 19/025,085

(22) Filed: Jan. 16, 2025

(30) Foreign Application Priority Data
Jan. 31, 2024 (JP) 2024-012694

(51) Int. Cl. G06F 3/12; H04N 1/00

(52) U.S. Cl. CPC G06F 3/1229; H04N 1/00891; H04N 1/00899

(57) ABSTRACT

An image forming apparatus according to the present invention is an image forming apparatus configured to be capable of performing image printing using power of a battery or power supplied from an external device, and includes a processor, and a memory storing a program which, when executed by the processor, causes the image forming apparatus to execute control processing of performing control to perform image printing, wherein in a case of performing image printing using power supplied from the external device, in the control processing, control is performed to perform predetermined notification if power required to perform image printing on one page of recording paper does not remain in the battery.

### BACKGROUND OF THE INVENTION

### Field of the Invention

The present invention relates to an image forming apparatus, a control method of the image forming apparatus, and a non-transitory computer readable, and more particularly to a thermal transfer type image forming apparatus and a control method thereof.

### Description of the Related Art

A sublimation type thermal transfer system image forming apparatus is an image forming apparatus that can print images captured by a digital still camera, a smartphone, or the like. In the sublimation type transfer system, a heated thermal head is pressed on an ink ribbon, and ink is sublimated from solid to gas, so as to adhere to a recording paper.

As an example of the sublimation type thermal transfer system image forming apparatus is a compact (portable) image forming apparatus with a built-in battery, for example. In this image forming apparatus, the battery is charged using power received from an external device via an external interface (e.g. USB). Some image forming apparatuses can perform printing using power (external power) supplied from an external device, even if the battery is not recharged. In the case of this type of image forming apparatus, printing can be performed using the power supplied from the external device, even if the state of the battery residual capacity (power remaining in the battery) is in a low battery state. Low battery state is a state where only power to print one page of recording paper (one page printing) remains in the battery.

However in the case where printing is started in the low battery state using the external power, printing may not complete if the supply of the external power is stopped in mid-printing. Further, depending on the battery residual capacity, the image forming apparatus may stop (system may shut down). If the system shuts down, retracting the thermal head may be difficult, and the ink ribbon and the recording paper may stick together, or the ink ribbon may be cut due to the heat of the thermal head.

### SUMMARY OF THE INVENTION

The present invention provides an image forming apparatus that can perform appropriate notification in the case of printing using external power.

An image forming apparatus according to the present invention is an image forming apparatus configured to be capable of performing image printing using power of a battery or power supplied from an external device, and includes a processor, and a memory storing a program which, when executed by the processor, causes the image forming apparatus to execute control processing of performing control to perform image printing, wherein in a case of performing image printing using power supplied from the external device, in the control processing, control is performed to perform predetermined notification if power required to perform image printing on one page of recording paper does not remain in the battery.

Further features of the present invention will become apparent from the following description of exemplary embodiments with reference to the attached drawings.

### BRIEF DESCRIPTION OF THE DRAWINGS

FIGS. 1A and 1B are external views of a printer;

FIG. 2 is a block diagram of a printer;

FIG. 3 is a developed view of an ink ribbon;

FIG. 4A is a cross-sectional view of a printer;

FIG. 4B is a cross-sectional view of a printer;

FIG. 4C is a cross-sectional view of a printer;

FIG. 4D is a cross-sectional view of a printer;

FIG. 4E is a cross-sectional view of a printer;

FIG. 5 if a flow chart of a print operation;

FIG. 6 if a flow chart of a print operation;

FIGS. 7A to 7E are schematic diagrams of various screens; and

FIG. 8 is a table indicating a correspondence between battery voltage and charging time.

### DESCRIPTION OF THE EMBODIMENTS

An embodiment of the present invention will be described in detail with reference to the drawings. In the following description, “printing” refers to the entire series of processing and operations, from performing image printing based on a print instruction from a user to discharging the paper. “Image printing” refers to processing and operations to form an image on recording paper by thermally transferring a transfer material (ink, overcoat) coated on an ink sheet to the recording paper, for example.

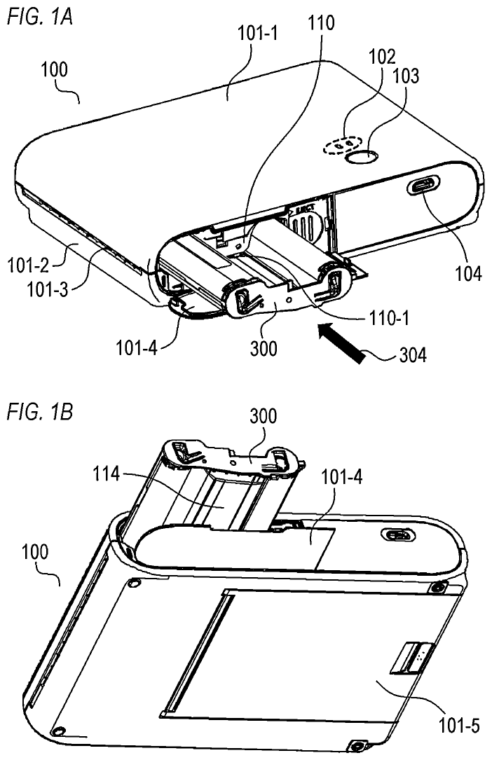

FIGS. 1A and 1B are external views of a printer 100, which is an image forming apparatus according to this embodiment, and an ink ribbon cassette 300 used in the printer 100. FIG. 1A is a perspective view viewed from the top side of the printer 100, and FIG. 1B is a perspective view viewed from the bottom side of the printer 100.

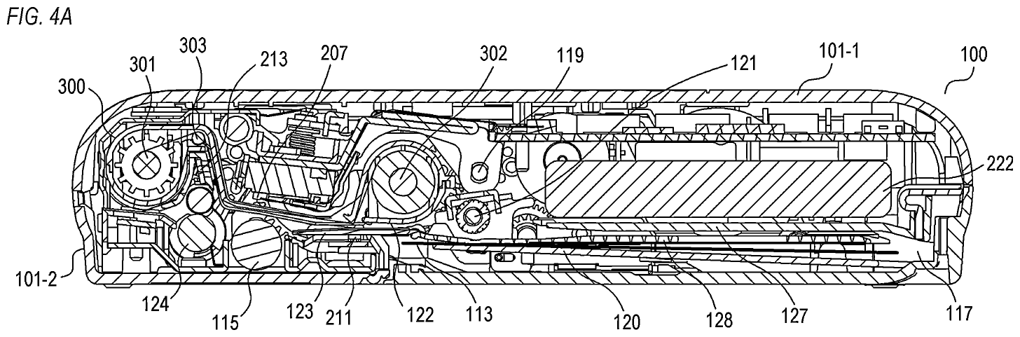

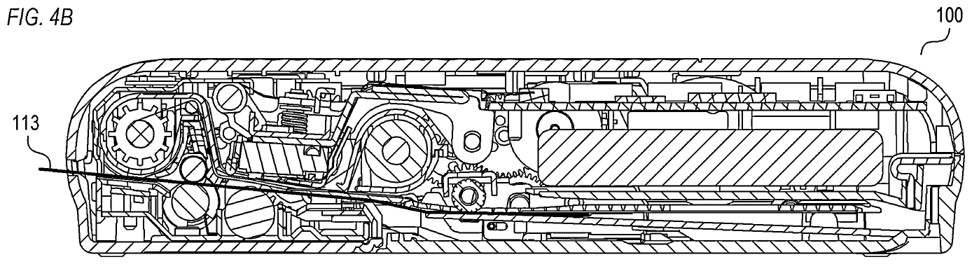

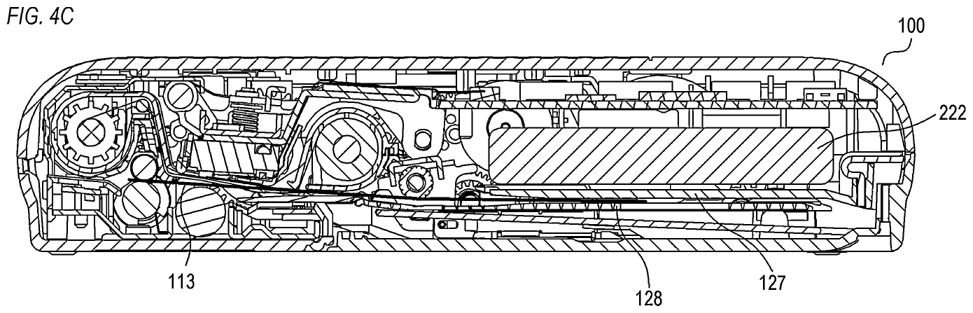

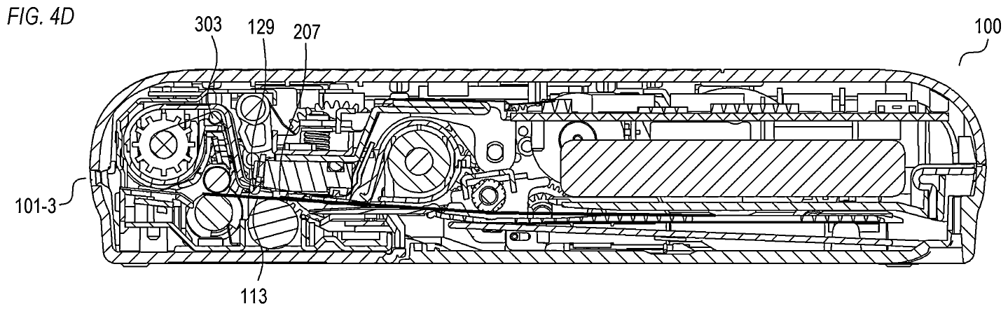

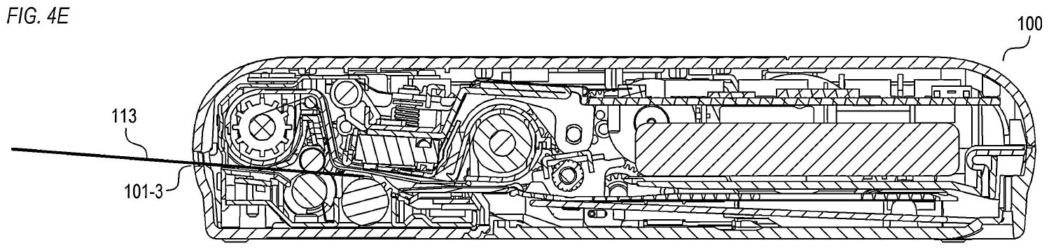

As illustrated in FIG. 1A, the printer 100 is covered by an upper main body case 101-1 and a lower main body case 101-2, which are the top and bottom exteriors. On one side face (one end side) of the printer 100, a paper delivery port 101-3 (opening), which is a space between the upper main body case 101-1 and the lower main body case 101-2, is created. During printing, recording paper 113 temporarily protrudes out of the printer 100 through the paper delivery port 101-3, or recording paper 113 after image printing is discharged through the paper delivery port 101-3. The recording paper 113 is indicated in FIGS. 4A to 4E, and is not illustrated in FIGS. 1A and 1B. A light-emitting unit 102 includes LEDs, and indicates the lighting or blinking of a plurality of colors of the LEDs through a window portion on the surface. By this lighting and blinking, the power supply state of the printer 100, and such status information on print operations and errors can be indicated. The power supply switch 103 is an operation button disposed adjacent to the light-emitting unit 102. By pressing the power supply switch 103, ON/OFF of the power supply of the printer 100 can be switched. On another side face of the printer 100, an openable cassette cover 101-4 is disposed, and a cassette installing portion 110-1 (opening portion) is disposed on a chassis 110 inside of the cassette cover 101-4. An ink ribbon cassette 300 can be installed inside of the cassette installing portion 110-1 in the direction of the arrow 304. In the ink ribbon cassette 300, an ink ribbon 114, on which a sublimation ink is coated, is stored. A USB connector 104, which is an external interface, is disposed on the same face as the installing surface of the ink ribbon cassette 300. A tray cover 101-5 is disposed on the bottom surface of the printer 100. When the tray cover 101-5 is opened, recording paper 113 for image printing can be stored in the printer 100.

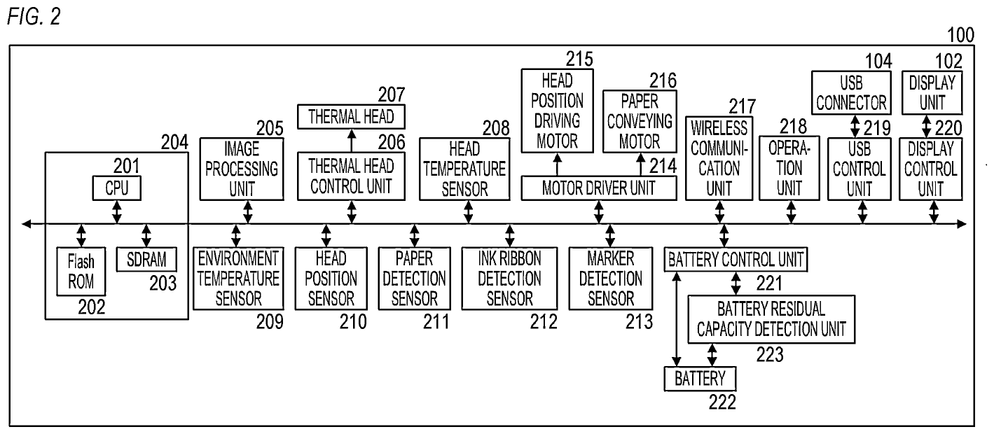

FIG. 2 is a block diagram of the printer 100 according to the present embodiment.

A CPU 201 performs the system control and arithmetic processing of the printer 100. A flash ROM 202 stores programs for controlling the system of the printer 100. The CPU 201 reads a program from the flash ROM 202 and controls each component based on the read program. An SDRAM 203 temporarily stores image data. The SDRAM 203 is used for operating the data processing. A portion constituted of the CPU 201, the flash ROM 202, and the SDRAM 203 is called a main control unit 204 which mainly processes each control of the printer 100. The functions and processing of the printer 100, which will be described later, are implemented by the CPU 201 reading the programs stored in the flash ROM 202, and executing the programs.

The image processing unit 205 performs image processing of image data sent from a portable terminal, such as a digital camera and a smartphone. The image processing unit 205 performs various image processing, such as decompression processing of compressed image data, resize processing in accordance with paper to be used, and image correction processing, and generates print data for image printing based on the image data generated after the image processing. The processing of the image processing unit 205 may be performed by the main control unit 204 instead of the image processing unit 205, or may be performed by both the image processing unit 205 and the main control unit 204.

A thermal head control unit 206 converts the print data generated by the image processing unit 205 into electric signals, and outputs the electric signals to a thermal head 207. The thermal head 207 converts the electric signal into thermal energy, and transfers the dye of the ink ribbon to the paper.

A head temperature sensor 208 measures the temperature of the thermal head 207. An environment temperature sensor 209 measures the environment temperature inside of the printer 100. A head position sensor 210 detects such positions as a pressing position and a retracting position of the head. A paper detection sensor 211 detects a position of paper. An ink ribbon detection sensor 212 detects information on the ink ribbon. A marker detection sensor 213 detects a marker that is set on the ink ribbon.

A motor driver unit 214 controls a motor. A head position driving motor 215 is a motor for driving the head to the pressing position for image printing, or the retracting position for exchanging the ink ribbon cassettes and for conveying paper. A paper conveying motor 216 is a motor for conveying the paper. The main control unit 204 sends an instruction to the motor driver unit 214 in accordance with the sensor information of each sensor mentioned above and the information programmed in advance, and controls the driving of the head position driving motor 215 and the paper conveying motor 216.

A wireless communication unit 217 controls wireless communication with an external device such as a digital camera. An operation unit 218 receives operation instruction information from the power supply switch 103 and the like disposed on the surface of the upper main body case 101-1. A USB control unit 219 determines information from an external apparatus connected to the USB connector 104 (external interface) and performs communication control, performs power transfer control, and performs transmission control of various data, such as operation information and image data. Power can be received from the outside by connecting an external power supply adaptor or the like to the USB connector 104 using a USB cable. Here the external interface is a USB connector, but the external interface is not limited to a USB connector, and may be a dedicated connector to connect an adapter dedicated to the printer 100, for example.

A display control unit 220 controls the output of the light-emitting unit 102, such as the lighting and blinking of the LEDs. A battery control unit 221 includes a charging circuit which performs charging control of a battery 222. A battery residual capacity detection unit 223 detects power remaining in the battery 222.

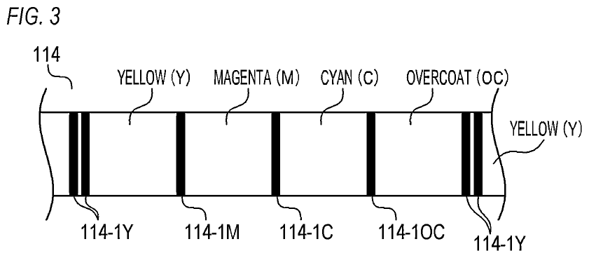

Now a configuration of an ink ribbon 114 will be described with reference to FIG. 3. FIG. 3 is a developed view of the ink ribbon 114. In a case of full color printing, it is common that an ink ribbon on which each color of yellow (Y), magenta (M) and cyan (C) is coated on the surface side by side is used as the ink ribbon 114, and each color is printed superimposed on an image printing medium, whereby a full color image is formed. Then a colorless transparent overcoat (OC) surface is formed. A black band-shaped marker 114-1 is formed among each color and the OC surface, so as to detect a head position of each surface. There are two markers 114-1Y to indicate the head position of the yellow (Y) surface (marker 114-1Y to distinguish between the yellow (Y) surface and another surface). There is one marker 114-1M to indicate the head position of the magenta (M) surface, one marker 114-1C to indicate the head position of the cyan (C) surface, and one marker 114-10C to indicate the head position of the OC surface. The ink ribbon 114 here is assumed to be a sublimation ink ribbon. A high heat resistant film, such as a polyethylene terephthalate film with a thickness of about 2 to 10 microns, is used as the base material. On this film, the sublimation ink prepared by mixing each eye, binder, plasticizer, bond and the like is coated to a 0.2 to 5 μm thickness, whereby each color dye coated surface of yellow (Y), magenta (M) and cyan (C) is formed. Further, on this film, styrene dielectric, styrene resin, styrene copolymer, binder and the like are coated to about a 0.5 to 5 μm thickness, whereby the colorless transparent overcoat surface is formed. On the opposite side of the surface on which ink is coated, a lubricating material, which decreases the frictional resistance with a sliding portion so as to stabilize the traveling of the ink ribbon, a polishing agent to polish and clean the surface of a thermal head, and the like are coated.

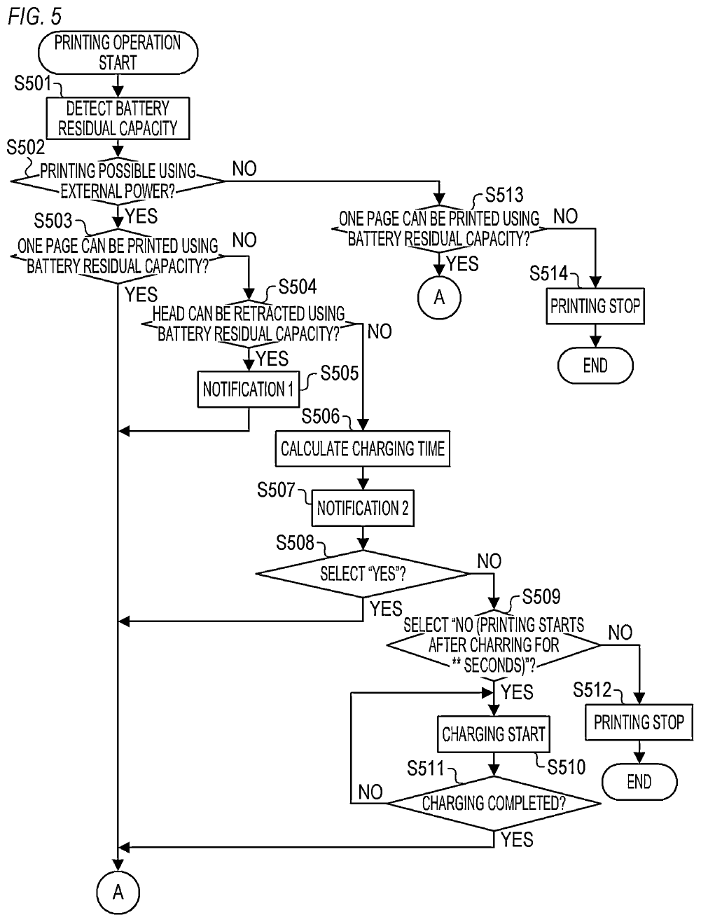

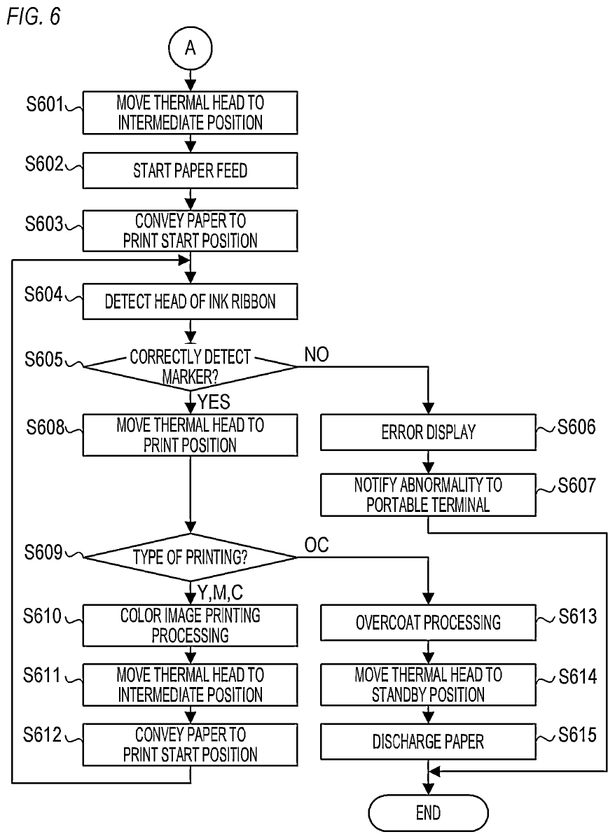

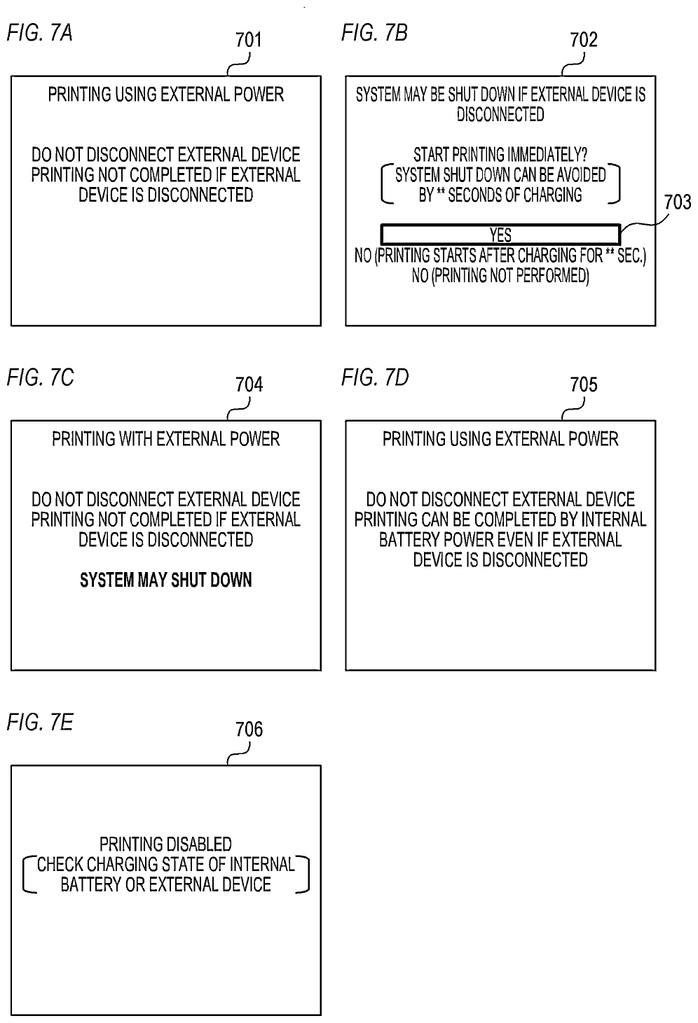

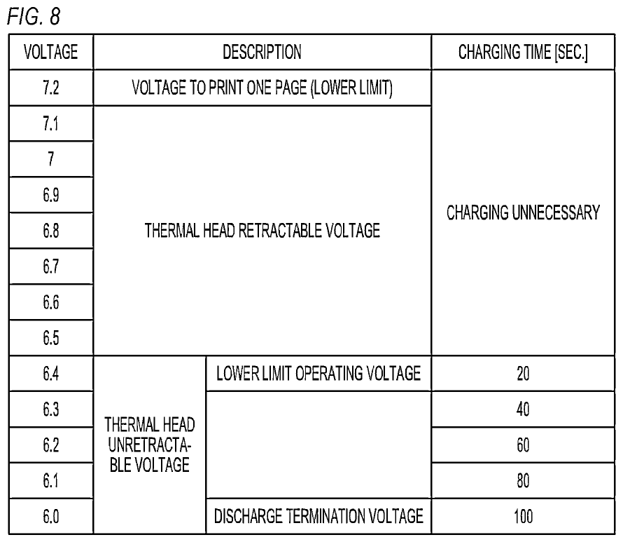

Now the print operation of the printer 100 will be described with reference to FIGS. 4A to 4E and FIGS. 5, 6, 7 and 8. FIGS. 4A to 4E are cross-sectional views to indicate an operation of the printer 100, and FIGS. 5 and 6 is a flow chart of the print operation of the printer 100. FIGS. 7A to 7E are schematic diagrams indicating various screens, and FIG. 8 is a table indicating a correspondence between voltage of the battery 222 and the charging time. FIG. 4A indicates an image printing standby state, FIG. 4B indicates a paper feeding state, FIG. 4C indicates a state during the image printing operation, FIG. 4D indicates a state after ending the image printing and before paper delivery, and FIG. 4E indicates a state after the paper delivery.

When the user sets the ink ribbon cassette 300 in the printer 100, loads the recording paper 113 in the paper storing unit 117, and presses the power supply switch 103, the printer 100 enters a standby state. The printer 100 includes a platen roller 115 and the thermal head 207. The thermal head 207 is rotatably supported by a thermal head rotating shaft 119, and is disposed at a position farthest possible from the platen roller 115, so that the ink ribbon cassette 300 does not interfere with the thermal head 207 when the ink ribbon cassette 300 is inserted or removed.

When the image data to be printed is specified on an operation terminal such as a digital camera and a smartphone and printing is instructed, the printer 100 receives print instruction information via the wireless communication unit 217. Then the printer 100 starts print operation. This operation is implemented by the CPU 201 of the printer 100 developing the program stored in the flash ROM 202 on the SDRAM 203, and executing the program.

In S501 in FIG. 5, the CPU 201 detects power (battery residual capacity) remaining in the battery 222 using the battery residual capacity detection unit 223. Since there are individual differences in batteries 222, it is difficult to estimate a correct battery residual capacity merely by measuring the open voltage of the battery 222. Therefore it is preferable to estimate the battery residual capacity at high accuracy using a drop amount in the battery voltage (voltage of the battery 222) when a pseudo-load close to an actual load is applied to the battery 222.

In S502, the CPU 201 determines whether or not printing can be performed using external power (power supplied from an external device) alone. Processing advances to S503 if printing can be performed using the external power, or advances to S513 is not.

Here a case where the external interface of the printer 100 is a dedicated connector, for connecting an adapter dedicated to the printer 100, will be considered. In this case, printing can be performed using the external power alone if the external device (adapter dedicated to the printer 100) is connected to the external interface. Therefore it is sufficient if the CPU 201 can determine only whether or not an external device is connected to the external interface, or whether or not external power is supplied to the external interface.

A case where the external interface of the printer 100 is a USB connector will now be considered. In this case, it is necessary to determine whether or not the external device has a power feeding capability to supply power required to perform printing. Here it is assumed that the printer 100 and the external device support USB PD, and the minimum power required to perform printer is 45 W. In this case, the CPU 201 communicates with the external device using a CC terminal, receives information on the printer feeding capacity of the external device, and determines whether or not the external device can supply at least 45 W of power, for example. If the external device can supply at least 45 W of power, printing can be performed using the external power alone. If the external device cannot supply at least 45 W of power, printing cannot be performed using the external power alone.

In S503, the CPU 201 determines whether or not image printing on one page of recording paper can be performed using the battery residual capacity detected in S501. Processing advances to S601 in FIG. 6 if image printing can be performed using the battery residual capacity, or advances to S504 if not. In the case of advancing from S503 to S601, the processing in steps S601 to S615 is performed using the external power.

In step S601, the CPU 201 controls the driving of the head position driving motor 215 using a driving force (not illustrated). Then the support portion of the thermal head 207 rotates counterclockwise in FIGS. 4A to 4E, around the thermal head rotating shaft 119, and as indicated in FIG. 4B, the thermal head 207 moves to an intermediate position between the standby position indicated in FIG. 4A, and the image printing position (position where a nip is generated with the platen roller 115) indicated in FIG. 4C.

When the moving of the thermal head 207 completes, the CPU 201 starts the paper feeding operation in S602. When the paper feeding operation starts, a pressing plate 120 included in the printer 100 is energized toward the paper feeding roller 121 by energizing means (not illustrated), pushes a recording paper 113, loaded in the paper storing unit 117, up to the paper feeding roller 121. At the standby position indicated in FIG. 4A, the paper feeding roller 121 is retracted to a position distant from the recording paper 113. In the intermediate position indicated in FIG. 4B, the paper feeding roller 121 is pushed up to a position that is in contact with the recording paper 113 by a driving force (not illustrated). Here the paper feeding roller 121 rotates counterclockwise indicated in FIGS. 4A to 4E, by the transfer of the driving force of the paper conveying motor 216 (not illustrated), and conveys the press-contacted recording paper 113 to an image printing recording portion which is constituted of the thermal head 207 and the platen roller 115. The recording paper 113 contacts with a separating bank 122 created in the printer 100, and only one sheet of recording paper 113, the sheet which is on the very top, is conveyed.

Then the conveyed recording paper 113 is detected by the paper detection sensor 211, and it is confirmed whether a paper feeding operation failure occurred. If there is no paper feeding operation failure, the recording paper 113, conveyed by the paper feeding roller 121, is rotated clockwise in FIGS. 4A to 4E, by a switching plate 123, which is rotatably supported, that is pushed upward, and advances in the left direction in FIGS. 4A to 4E. Then the recording paper 113 enters into the nip between a conveying roller 124 and a conveying driven roller 125. On the conveying roller 124, a plurality of microscopic protrusions, which pierce the rear face of the recording paper 113, are formed, whereby the recording paper 113 can be accurately conveyed. The conveying roller 124 is driven by the paper conveying motor 216 (not illustrated). The paper conveying motor 216 is a stepping motor, and can accurately control the feed amount.

After the recording paper 113 is conveyed to the nip between the conveying roller 124 and the conveying driven roller 125, the paper feeding roller 121 moves to a position disposed in the standby state indicated in FIG. 4A by a driving force (not illustrated). This is to prevent other sheets of paper in the paper storing unit 117 from being conveyed by the paper feeding roller 121 in error. Then the recording paper 113 is continuously conveyed by the conveying roller 124 and the conveying driven roller 125, and the rear end of the recording paper 113 passes through the paper detection sensor 211. After the recording paper 113 is conveyed for a predetermined amount and exits the front end of the switching plate 123, conveying stops. Then in step S603, the CPU 201 conveys the recording paper 113 in the opposite direction and stops the recording paper 113 at an image printing start position, indicated in FIG. 4C. Here during feeding, the rear end of the recording paper 113 passes the upper side of the switching plate 123, passes the lower side of the paper feeding roller 121, and is conveyed into a space between a guide wall 127, which separates and holds the lower part of the battery 222, and a paper storage unit wall 128.

When the paper feeding operation ends and the recording paper 113 stops at the image printing start position, the CPU 201 performs a head detection operation of the ink ribbon 114 in step S604.

Now the head direction operation of the ink ribbon 114 will be described. When the paper is conveyed to the position indicated in FIG. 4C, and conveying to the image printing start position completes, the ink ribbon 114 stored in the ink ribbon cassette 300 is wound up. In other words, the tip of a winding shaft 301, disposed inside of the ink ribbon cassette 300, is engaged with an engaging unit included in the printer 100, and is rotated counterclockwise in FIGS. 4A to 4E by a driving force (not illustrated). Then, the ink ribbon 114, wound around a supply shaft 302, is wound up around the winding shaft 301. As illustrated in FIG. 2, a marker is disposed in the head position of each color of the ink ribbon 114. Two markers are disposed in the beginning of yellow (Y), and one marker is disposed in each of the beginning of magenta (M), cyan (C) and overcoat (OC) respectively. The printer 100 includes the marker detection sensor 213, which is a reflection type optical sensor, and conveying of the ink ribbon is stopped and head detection is performed when the marker (interruption of reflection light by the marker) disposed on the ink ribbon 114 is detected.

In S605, the CPU 201 determines whether the marker is corrected detected. In the case of the head detection of yellow (Y), it is determined whether the two markers are detected within a predetermined time, and in the case of the head detection of magenta (M), cyan (C) and overcoat (OC), it is determined whether the one marker is detected within a predetermined time. Processing advances to step S608 if the markers were correctly detected (a predetermined number of markers were detected within a predetermined time), or advances to S606 if not.

In S606, the CPU 201 causes the light-emitting unit 102 to blink, which indicates an abnormality (error) of the ink ribbon cassette 300. In S607, the CPU 201 notifies the operation terminal of the abnormality generated in the ink ribbon via the wireless communication unit 217.

When the head detection completes, the CPU 201 in S608 rotates the unit holding the thermal head 207 counterclockwise in FIGS. 4A to 4E around the thermal head rotating shaft 119. Thereby the thermal head 207 moves to the image printing position where the ink ribbon 114 and the recording paper 113 are held between the thermal head 207 and the platen roller 115.

When the thermal head 207 moves to the image printing position, the CPU 201 determines a type of image printing in S609. Then the head detection of yellow (Y), magenta (M) or cyan (C) is performed, and processing advances to S610 if printing of this color is performed, or advances to S613 if not.

In S610, the CPU 201 performs image printing of the color of which head was detected. As illustrated in FIG. 4D, the recording paper 113 and the ink ribbon 114 are pressed and held between the thermal head 207 and the platen roller 115, and are conveyed in this state toward the paper delivery port 101-3 while being heated by the thermal head 207. Thus, the ink coated on the ink ribbon 114 is transferred to the recording paper 113 and image printing is performed thereby. The ink ribbon conveying mechanism included in the printer 100 encloses a torque limiter mechanism (not illustrated) which slips when load a predetermined torque or more is applied, and the ink ribbon 114 and the recording paper 113 are conveyed at the same speed during the image printing operation. When the image printing performed with heating by the thermal head 207, the ink ribbon 114 and the recording paper 113 are conveyed maintaining the contacted state for a predetermined distance, then are conveyed in directions separating from each other. In other words, the recording paper 113 is conveyed in the left direction in FIGS. 4A to 4E by the conveying roller 124, and the ink ribbon 114 is conveyed toward a guide shaft 303 disposed inside of the ink ribbon cassette 300, while sliding on a separating plate 129 which is integrated with the thermal head 207. The ink ribbon 114 is adhered to the recording paper 113 through heating by the thermal head 207, but is separated from the recording paper 113 when conveyed to the position of the separating plate 129.

When the image printing of the color of which head was detected completes, the CPU 201 in S611 rotates the unit holding the thermal head 207 by a driving force (not illustrated), and retracts the unit from the recording paper 113 to the intermediate position indicated in FIG. 4B. Then in S612, the CPU 201 conveys the recording paper 113 in the opposite direction, and stops the recording paper 113 at an image printing start position indicated in FIG. 4C.

When the image printing of yellow (Y), magenta (M) and cyan (C) completes, the CPU 201 performs image printing of overcoat (OC) in S613. As mentioned above, ink dye is transferred in the image printing of yellow (Y), magenta (M) and cyan (C). In the overcoat processing (image printing of overcoat), the above mentioned resin is melted and transferred in order to form the overcoat layer. By transferring the overcoat layer, a uniform gloss can be applied on the entire surface of the recording paper 113. Further, information can be recorded on the overcoat layer as well by the thermal head 207 changing the transfer amount of the coat resin to form the overcoat layer. Specifically, by partially supplying energy higher than usual by controlling the output (heat value) of the thermal head 207, the surface of the protective layer of the coat resin can be roughened, and a low gloss area can be formed. Further, by partially changing the gloss of the surface of the recording paper 113, the impression (texture) of the printed matter can be changed. Information can also be recorded using the difference in gloss (surface treatment).

When the image printing of the overcoat completes, the CPU 201 in S614 rotates the unit holding the thermal head 207 by a driving force (not illustrated), and retracts the unit from the recording paper 113 to the standby position indicated in FIG. 4E. Then in S615, the CPU 201 further conveys the recording paper 113 from the paper delivery port 101-3 in the discharging direction. Paper delivery completes when the rear end of the paper exits the conveying roller 124. When paper delivery completes, the printer 100 ends the print operation. Thus, the ink and resin are superimposed and transferred in the sequence of yellow, magenta, cyan and overcoat, whereby the image printing operation completes.

Description now returns to FIG. 5. As described above, if it is determined that no power remains in the battery 222 to print on one page of recording paper in S503, the processing proceeds to S504.

In S504, the CPU 201 determines whether or not the thermal head 207 can be retracted from the image printing position using the battery residual capacity detected in S501. For example, a threshold has been stored in the flash ROM 202 or the like, and the CPU 201 determines whether or not the battery residual capacity is higher than the threshold. Processing advances to S505 if the thermal head can be retracted using the battery residual capacity (if the battery residual capacity is higher than the threshold), or advances to S506 if not. The threshold is preferably a value that takes into account a major voltage drop in the case of a low temperature time or the like. The printer 100 may include a temperature sensor to detect the temperature inside the printer 100. Further, the CPU 201 may determine or change the threshold in accordance with the temperature inside the printer 100. For example, the CPU 201 may determine the threshold considering the voltage drop that is greater as the temperature inside the printer 100 is lower.

The battery residual capacity required to retract the thermal head 207 is a battery residual capacity with which the thermal head 207 can be retracted from the image printing position when the image printing is started using the external power and disconnection of the external device is detected during the image printing. In the case where the external device is disconnected during the image printing, it is necessary that the battery voltage does not drop (decrease) to a voltage where the printer 100 stops (voltage at which system shut down is generated), even if the load of the image printing is applied to the battery 222 until disconnection is detected. Therefore the battery residua capacity required to retract the thermal head 207 is the battery residual capacity with which system shutdown is not generated even if the load of the image printing is applied to the battery 222 until the disconnection of the external device is detected.

In S505, the CPU 201 controls to perform predetermined notification to the user. The predetermined notification is performed using at least one of: the display unit (e.g. LCD) of the printer 100, the light-emitting unit (e.g. LED) of the printer 100, and a display unit of an operation terminal connected to the printer 100. For example, the CPU 201 displays a warning screen 701 in FIG. 7A on the display unit of the printer 100, or sends a control signal, to display the warning screen 701 on the display unit of the operation terminal, to the operation terminal, or turns on the light-emitting unit of the printer 100 with a red light. For a situation that the printer 100 may be subject to after the power supply from the external device stops (a situation that the printer 100 has a possibility of encountering after the power supply from the external device stops), a text, “printing not completed if external device is disconnected”, indicating the situation where the image printing (printing) cannot be completed, is displayed on the warning screen 701. A text advising caution to not stop power supply from the external device, “do not disconnect external device”, is also displayed on the warning screen 701. However display of one of these two texts may be omitted. After S505, processing advances to S601 in FIG. 6. If processing advances from S505 to S601, the processing in S601 to S615 is performed using the external power.

In S506, the CPU 201 acquires information on the time required to charge the battery 222 (charging time) up to the power level at which the thermal head 207 can be retracted from the image printing position. For example, a table in FIG. 8 (table indicating correspondence between the battery voltage and charging time) has been stored in the flash ROM 202 or the like. Then the CPU 201 reads the charging time corresponding to the current battery voltage (battery voltage corresponding to the battery residual capacity detected in S501) from the table in FIG. 8. The table in FIG. 8 indicates the battery voltage, the description on battery voltage, and the charging time. In the case of using the FG battery or the like, the required battery time may be calculated based on the charging current, the battery voltage, and the power required to retract the thermal head 207.

In S507, the CPU 201 controls to perform predetermined notification to the user. For example, the CPU 201 displays the warning screen 702 in FIG. 7B on the display unit of the printer 100, or sends a control signal, to display the warning screen 702 on the display unit of the operation terminal, to the operation terminal. For a situation that the printer 100 may be subject to after the power supply from the external device stops, a text, “system may shut down if external device is disconnected”, indicating the situation where a system shutdown is generated, is displayed on the warning screen 702. A text indicating the inquiry prompting whether or not image printing (printing) is performed, “start printing immediately?”, and three choices responding to this prompt are also displayed on the warning screen 702. The three choices are “YES”, “NO (printing starts after charging for ** seconds)”, and “NO (printing not performed)”. A cursor 703 is also displayed on the warning screen 702, and the user can select one of “YES”, “NO (printing starts after charging for ** seconds)”, and “NO (printing not performed)” by using the cursor 703. “YES” is a choice to perform image printing (printing) without charging the battery 222 up to the power level at which the thermal head 207 can be retracted from the image printing position. “NO (printing starts after charring for ** seconds)” is a choice to charge the battery 222 up to the power level at which the thermal head 207 can be retracted from the image printing position, and to then perform the image printing (printing). “NO (printing not performed)” is a choice to stop the image printing (printing). “** seconds” indicates the charging time acquired in S506. Display of “** seconds” may be omitted. Further, display of any one of “YES”, “NO (printing starts after charging for ** seconds)”, and “NO (printing not performed)” may be omitted. Furthermore, text of these choices may be appropriately changed. For example, “NO (printing starts after charging for ** seconds)” may be changed to “printing starts after charging”. Display of “system may shutdown if external device is disconnected” may be omitted.

If the system shuts down without retracting the thermal head 207 from the image printing position, the ink ribbon and the recording paper may stick together, or the ink ribbon may be cut due to the heat of the thermal head 207. In some cases, the user may connect the external device to the printer 100 when the battery residual capacity decreased to a power level at which one page of recording paper cannot be printed (one page printing is impossible). In this case, the user recognizes that one page printing is impossible by the battery residual capacity alone when printing is started, without the above mentioned notifications. However if the supply of the external power stops in mid-printing, the user cannot recognize the situation that the printer 100 may be subject to. For example, the user cannot recognize whether the system may shut down or whether the thermal head 207 can be retracted from the image printing position. Hence the user cannot recognize what action they should take. For example, the user cannot recognize whether they must pay close attention not to disconnect the external device from the printer 100 (e.g. not to unintentionally pull the cable with their foot or the like), or whether they may leave the printer 100 and the external device untouched. In the present embodiment, a different notification is outputted depending on the possibility that the thermal head 207 cannot be retracted from the image printing position (possibility of generating a system shut down), as indicated in FIGS. 7A and 7B, so that the user can take appropriate action.

In S508, the CPU 201 determines whether “YES” in FIG. 7B is selected. Processing advances to S601 in FIG. 6 if “YES” is selected, or advances to S509 if not. In the case of advancing from S508 to S601, the processing in S601 to S615 is performed using external power.

In the case of advancing from S508 to S601, the CPU 201 may control to perform a predetermined notification to the user. For example, the CPU 201 may display the warning screen 704 in FIG. 7C on the display unit of the printer 100, or send a control signal, to display the warning screen 704 on the display unit of the operation terminal, to the operation terminal, or may turn on the light-emitting unit of the printer 100 with a blinking red light.

For a situation that the printer 100 may be subject to after the power supply from the external device stops, the text, “printing not completed if external device is disconnected”, indicating the situation where the image printing (printing) cannot be completed, is displayed on the warning screen 704. Further, for a situation that the printer 100 may be subject to after the power supply from the external device stops, the text “system may shut down”, indicating the situation where a system shut down is generated, is also displayed on the warning screen 704. Furthermore, the text advising caution to not stop power supply from the external device, “do not disconnect external device”, is also displayed on the warning screen 704. However display of one or two of these three texts may be omitted.

In the case of advancing from S503 to S601, the CPU 201 may control to perform a predetermined notification to the user. For example, the CPU 201 may display the warning screen 705 in FIG. 7D on the display unit of the printer 100, or send a control signal, to display the warning screen 705 on the display unit of the operation terminal, to the operation terminal, or may turn on the light-emitting unit of the printer 100 with a green light. For a situation that the printer 100 may be subject to after the power supply from the external device stops, a text, “printing can be completed by internal battery power even if external device is disconnected”, indicating the situation that image printing (printing) can be completed, is displayed on the warning screen 705. Furthermore, a text advising caution to not stop power supply from the external device, “do not disconnect external device”, is also displayed on the warning screen 705. However display of one or of these two texts may be omitted.

In S509, the CPU 201 determines whether “NO (printing starts after charring for ** seconds)” in FIG. 7B is selected. Processing advances to S510 if “NO (printing starts after charging for ** seconds)” is selected, or advances to S512 if not (if “NO (printing not performed)” is selected).

In S510, the CPU 201 starts charging the battery 222 using external power.

In S511, the CPU 201 determines whether the battery 222 is charged to the power level at which the thermal head 207 can be retracted from the image printing position. Specifically, the CPU 201 determines whether or not the time acquired in S506 (time required to charge the battery 222 to the power level at which the thermal head 207 can be retracted) from the image printing position has elapsed since S510 (start of charging of the battery 222). Processing waits for completion of charging (elapse of time acquired in S506), and processing advances to S601 in FIG. 6 if the time acquired in S506 elapsed. In the case of advancing from S511 to S601, the processing in S601 to S615 is performed using the external power. In the case of advancing from S511 to S601, the CPU 201 may control to perform a predetermined notification to the user. For example, the CPU 201 may display the warning screen 701 in FIG. 7A on the display unit of the printer 100, or send a control signal, to display the warning screen 701 on the display unit of the operation terminal, to the operation terminal, or may turn on the light-emitting unit of the printer 100 with a red light.

In S512, the CPU 201 stops printing. Then the printer 100 ends the printing operation.

In the case of omitting S506 to S512 and determining in S504 that the thermal head 207 cannot be retracted by the battery residual capacity, a predetermined notification (e.g. displaying the warning screen 704 in FIG. 7C) may be performed, and processing may advance to S601. In the case of omitting S506 to S509 and S512 and determining in S504 that the thermal head 207 cannot be retracted by the battery residual capacity, processing may advance to S510. In this case as well, a predetermined notification (e.g. displaying the warning screen 701 in FIG. 7A) may be performed when the processing advances from S511 to S601.

As mentioned above, processing advances to S513 if it is determined in S502 that printing cannot be performed using the external power alone.

In S513, the CPU 201 determines whether or not image printing is possible for one page of recording paper using the battery residual capacity detected in S501. Processing advances to S601 in FIG. 6 if the image printing is possible using the battery residual capacity, or advances to S514 if not. In the case of advancing from S513 to S601, the processing in S601 to S615 is performed using the battery residual capacity.

In S514, the CPU 201 controls to perform a predetermined notification to the user. For example, the CPU 201 displays the warning screen 706 in FIG. 7E on the display unit of the printer 100, or sends a control signal, to display the warning screen 706 on the display unit of the operation terminal, to the operation terminal, or may turn on the light-emitting unit of the printer 100 with a fast blinking red light. A text “printing disabled (check charging state of internal battery or external device)”, indicating that the image printing (printing) cannot be performed, is displayed on the warning screen 706. Then the printer 100 ends the printing operation.

A concrete example of the operation of the present embodiment will now be described with reference to the table in FIG. 8.

In the case where it is determined that printing cannot be performed using the external power alone in S502 in FIG. 5, image printing is performed using the battery residual capacity if the battery voltage is 7.2V (lower limit voltage sufficient to perform one page printing) or more (YES in S513). If the battery voltage is less than 7.2V (NO in S513), a predetermined notification, such as displaying the warning screen 706 in FIG. 7E, is performed.

In the case where it is determined that printing is possible using the external power alone in S502, image printing is performed using the external power if the battery voltage is 7.2V or more (YES n S503). If the battery voltage is 6.5V or more and less than 7.2V (voltage required to retract the thermal head 207) (NO in S503 and YES in S504), a predetermined notification, such as displaying the warning screen 701 in FIG. 7A, is performed (S505). If the battery voltage is less than 6.5V (voltage by which retraction of the thermal head 207 is impossible) (NO in S503 and NO in S504), a predetermined notification, such as displaying the warning screen 702 in FIG. 7B, is performed (S507). For example, if the battery voltage is 6.4V, “40 seconds” is displayed as the charging time of the battery 222 to reach the power level at which retraction of the thermal head 207 is possible. In FIG. 8, the lower limit operating voltage of the battery 222 is 6.3V, and the discharge termination voltage of the battery 222 is 6.0V.

As described above, according to the present embodiment, an appropriate notification can be displayed in the case of using the external power. For example, a different notification is displayed depending on whether or not the thermal head can be retracted (whether or not a system shut down is generated) after the supply of the external power stops in mid-printing. Thereby the user can recognize the situation that the printer may be subject to in the case where the supply of the external power stops in mid-printing, and can take appropriate action accordingly. Further, the choice to start printing after recharging the battery is provided, which improves user friendliness. For example, the user need not be concerned with the surroundings of the printer after printing starts, so that the external device is not disconnected from the printer, and can depart from the printing site and return to pick up the printed matter when charging and printing is over.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, an appropriate notification can be performed in the case of printing using external power.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-012694, filed on Jan. 31, 2024, which is hereby incorporated by reference herein in its entirety.

What is claimed is:

1. An image forming apparatus configured to be capable of performing image printing using power of a battery or power supplied from an external device, comprising:
a processor; and
a memory storing a program which, when executed by the processor, causes the image forming apparatus to execute control processing of performing control to perform image printing, wherein
in a case of performing image printing using power supplied from the external device, in the control processing, control is performed to perform predetermined notification if power required to perform image printing on one page of recording paper does not remain in the battery.

2. The image forming apparatus according to claim 1, wherein
the predetermined notification indicates at least one of a situation that the image forming apparatus has a possibility of encountering after power supply from the external device stops, and a caution advising not to stop the power supply from the external device.

3. The image forming apparatus according to claim 1, wherein
the predetermined notification is performed using at least one of a display of the image forming apparatus, a lamp of the image forming apparatus, and a display of an operation terminal connected to the image forming apparatus.

4. The image forming apparatus according to claim 1, wherein
in a case of performing image printing using power supplied from the external device, in the control processing,
control is performed to perform a first notification if power required to perform image printing on one page of recording paper does not remain in the battery, but power required to retract the thermal head from an image printing position remains in the battery, and
control is performed to perform a second notification, if neither the power required to perform printing on one page of recording paper nor the power required to retract the thermal head from the image printing position remains in the battery.

5. The image forming apparatus according to claim 4, wherein
the first notification indicates a situation in which image printing is not completed, as the situation that the image forming apparatus has a possibility of encountering, and
the second notification indicates a situation in which the image forming apparatus shuts down, as the situation that the image forming apparatus has a possibility of encountering.

6. The image forming apparatus according to claim 4, wherein
the second notification includes an inquiry prompting whether or not the image printing is performed.

7. The image forming apparatus according to claim 6, wherein
the inquiry includes choices of:
performing image printing without charging the battery up to the power required to retract the thermal head from the image printing position;
performing image printing after charging the battery up to the power required to retract the thermal head from the image printing position; and
not performing image printing.

8. The image forming apparatus according to claim 7, wherein
the second notification further indicates time to charge the battery up to the power required to retract the thermal head from the image printing position.

9. The image forming apparatus according to claim 7, wherein
in a case of selecting a choice of performing image printing without charging the battery up to the power required to retract the thermal head from the image printing position, in the control processing, control is performed to perform a third notification.

10. The image forming apparatus according to claim 9, wherein
the third notification indicates a situation in which the image forming apparatus shuts down, as the situation that the image forming apparatus has a possibility of encountering.

11. The image forming apparatus according to claim 10, wherein
the third notification further indicates a situation in which the image printing is not completed, as a situation that the image forming apparatus has a possibility of encountering.

12. The image forming apparatus according to claim 1, wherein
in a case of performing image printing using power supplied from the external device, in the control processing, control is performed to perform a fourth notification if power required to perform image printing on one page of recording paper does not remain in the battery, and it is not possible to supply power required to print one page of recording paper from the external device.

13. The image forming apparatus according to claim 12, wherein
the fourth notification indicates that image printing is not possible.

14. A control method of an image forming apparatus configured to be capable of performing image printing using power of a battery or power supplied from an external device, the control method comprising:
performing control to perform image printing; and
performing, in a case of performing image printing using power supplied from the external device, control to perform predetermined notification if power required to perform image printing on one page of recording paper does not remain in the battery.

15. A non-transitory computer readable medium that stores a program, wherein the program causes a computer to execute a control method of an image forming apparatus configured to be capable of performing image printing using power of a battery or power supplied from an external device, the control method comprising:
performing control to perform image printing; and
performing, in a case of performing image printing using power supplied from the external device, control to perform predetermined notification if power required to perform image printing on one page of recording paper does not remain in the battery.
